(19) United States
(12) Patent Application Publication
(10) Pub. No.: US 2009/0030705 A1
(43) Pub. Date: Jan. 29, 2009

(54) PROJECT MANAGEMENT BLACK BOX PROTECTIONS

(76) Inventors: Michel Shane Simpson, American Fork, UT (US); Volker Gunnar Scheuber-Heinz, Pleasant Grove, UT (US); Lee Edward Lowry, Orem, UT (US); Stephen R. Carter, Spanish Fork, UT (US); William Street, Orem, UT (US)

Correspondence Address: SCHWEGMAN, LUNDBERG & WOESSNER/NOVELL, PO BOX 2938, MINNEAPOLIS, MN, 55402, US

(21) Appl. No.: 11/781,325

(22) Filed: Jul. 23, 2007

(51) Int. Cl. G06Q 10/00

(52) U.S. Cl. 705/1

(57) ABSTRACT

Techniques for project management black box protections are provided. A first principal associated with a first processing environment and a first stage of a project's lifecycle requests that an action be taken on its behalf. The first principal is authenticated and policy is evaluated when the first principal is successfully authenticated. Moreover, the action is taken on behalf of the principal when the policy permits and the when the principal was successfully authenticated.

### BACKGROUND

Increasingly enterprises and governments are turning to technology to automate and streamline their internal operations and business processes. Furthermore, the advent of the Internet and the World-Wide Web (WWW) has allowed enterprises and governments to delivery goods and services in an automated and nearly instantaneous fashion across the entire globe.

With any good or service provided by an enterprise or a government, there can be potentially a myriad of activities and expenses associated with those activities, which the enterprise or government endures before the good or service is available in the marketplace for consumption.

For example, word processing software has to be initially defined, developed and tested before it can be released for sale. These activities are usually managed internally by high-salaried project managers. For the most part, the project managers are administrators with skill in acquiring other personnel and equipment within an enterprise to make a project move from conception and development to release. In some cases, projects are so large within an enterprise that multiple layers of project managers are needed for any given project.

In large part, the industry has not been able to successfully automate and streamline the project management process. As a result, the cost of goods and services are likely unduly inflated and the time-to-market for goods and services is longer than it probably should be.

One reason for this lack of automation is the perceived complexity associated with project management in general. There are a variety of considerations such as laws, regulations, internal procedures that have to be followed. In addition, there may be limited personnel with specific skill sets some of which may be in high demand and unavailable within the enterprise and some of which the enterprise does not have and will have to contract out or hire in order to obtain.

Moreover, even when a manually implemented project management system is in place within an enterprise, there often arises a variety of complex security situations that necessitate regular modifications to that system. Trying to enforce new security procedures complicates and slows the ongoing project management. As a result, security may be intentionally relaxed when it should not be or even more manual steps may be introduced, within the project management system, in an attempt to enforce the new security procedures. It is apparent that neither approach is a desirable situation for an enterprise.

Thus, what is needed is an automated mechanism, which allows for improved project management security protections.

### SUMMARY

In various embodiments, techniques for project management black box protections are provided. More specifically, and in an embodiment, a method is provided for project management black box protections. A request is received from a first principal to take an action on behalf of the first principal within a first processing environment. The request is received within a context of a first stage for a lifecycle of a project. Next, the first principal is authenticated and policy is evaluated when the first principal is successfully authenticated. Finally, the action is taken on behalf of the first principal when policy permits and when the first principal is successfully authenticated.

### BRIEF DESCRIPTION OF THE DRAWINGS

FIG. 1 is a diagram of a method for project management black box protections, according to an example embodiment.

FIG. 2 is a diagram of a method for facilitating project management black box protections, according to an example embodiment.

FIG. 3 is a diagram of a project management back box protection system, according to an example embodiment.

FIG. 4 is a diagram of another project management black box protection system, according to an example embodiment.

### DETAILED DESCRIPTION

A “resource” includes a user, content, a processing device, a node, a service, an application, a system, a schema definition, a directory, an operating system (OS), a file system, a data store, a database, a policy definition, a configuration definition, a file, a World-Wide Web (WWW) service, a WWW page, groups of users, combinations of these things, etc. The terms “service,” “application,” and “system” may be used interchangeably herein and refer to a type of software resource that includes instructions, which when executed by a machine performs operations that change the state of the machine and that may produce output.

A “principal” is a special type of resource that performs one or more actions against other resources. So a principal may be a user or an automated service.

In an embodiment, each resource is electronically defined and represented as having one or more attributes. Each attribute includes one or more name value pairs. For example, a server resource may include an attribute associated with its physical Internet Protocol (IP) address and that attribute may be represented by the following name value pair: “IP=100.1.1.10.” The server resource may also have its own identity (discussed below) and may include other attributes such as whether the IP address is static or dynamic, etc. Attributes may also include references to policy or even specific configuration details for a given processing environment that a resource is to be deployed to.

A “project” refers to the activity associated with an enterprise or government producing a good (product) or personal service (e.g., financial advice, etc.) for consumption in the marketplace. The activity for the project is defined in various stages of the project's lifecycle, such as by way of example only project definition, project development, project testing, project release, etc. Thus, a “project” is represented and electronically defined as a series of stages associated with the project's lifecycle. Each stage includes its own processing environment having its own or shared resources. So, a stage is represented and electronically defined as one or more resources and their relationships with other resources of the same stage or a different stage. A project may also be viewed as a type of resource.

A “processing environment” refers to one or more physical processing devices organized within a local network. For example, several computers connected via a local area network (LAN) may collectively be viewed as a processing environment. The processing environment also refers to software configurations of the physical processing devices, such as but not limited to operating system, file system, directory service, etc. A single processing environment may be logically defined, such that it spans multiple different networks (e.g., multiple different LAN's, a LAN and a wide-area network (WAN), etc.).

An “identity service” refers to a special type of service that is designed to manage and supply authentication services and authentication information for resources. So, an identity service may authenticate a given resource for access to a variety of local and external services being managed by that identity service. A single resource may have multiple identity services. In addition the identity service itself may be viewed as a type of resource. In this manner, identity service may authenticate and establish trust with one another viewing one another as specific type of resource.

According to an embodiment, some example identity services are described in “Techniques for Dynamically Establishing and Managing Authentication and Trust Relationships,” filed on Jan. 27, 2004, and having the U.S. Ser. No. 10/765,523; “Techniques for Establishing and Managing a Distributed Credential Store,” filed on Jan. 29, 2004, and having the U.S. Ser. No. 10/767,884; and “Techniques for Establishing and Managing Trust Relationships,” filed on Feb. 3, 2004, and having the U.S. Ser. No. 10/770,677; all of which are commonly assigned to Novell, Inc., of Provo, Utah and the disclosures of which are incorporated by reference herein.

An identity service may also provide single sign-on services to a resource. That is, a resource may sign-on to an identity service and acquire identities and credentials to access a variety of other services or resources. In some cases, the identity service is modified or enhanced to perform some of the teachings presented herein and below.

A resource is recognized via an “identity.” An identity is authenticated via various techniques (e.g., challenge and response interaction, cookies, assertions, etc.) that use various identifying information (e.g., identifiers with passwords, biometric data, hardware specific data, digital certificates, digital signatures, etc.). A “true identity” is one that is unique to a resource across any context that the resource may engage in over a network (e.g., Internet, Intranet, etc.). However, each resource may have and manage a variety of identities, where each of these identities may only be unique within a given context (given service interaction, given processing environment, given virtual processing environment, etc.).

The identity may also be a special type of identity that the resource assumes for a given context. For example, the identity may be a “crafted identity” or a “semantic identity.” An example for creating and using crafted identities may be found in U.S. patent application Ser. No. 11/225,993; entitled “Crafted Identities;” filed on Sep. 14, 2005; and the disclosure of which is incorporated by reference herein. An example for creating and using semantic identities may be found in U.S. patent application Ser. No. 11/261,970; entitled “Semantic Identities;” filed on Oct. 28, 2005; and the disclosure of which is incorporated by reference herein.

Various embodiments of this invention can be implemented in existing network architectures, security systems, data centers, and/or communication devices. Any particular architectural layout or implementation presented herein is provided for purposes of illustration and comprehension only and is not intended to limit aspects or embodiments of the invention.

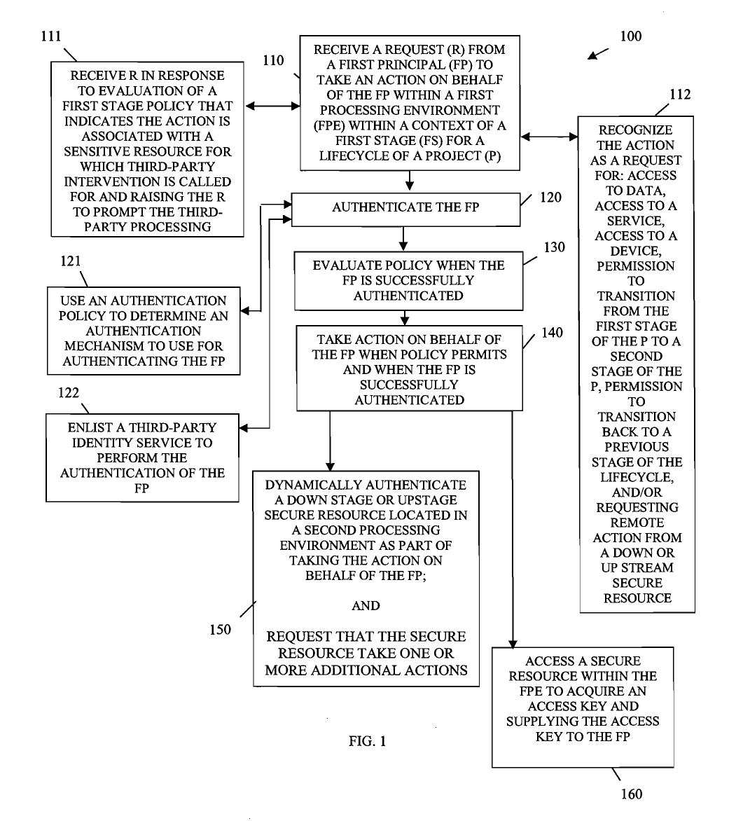

It is within this context, that various embodiments of the invention are now presented with reference to the FIGS. 1-4.

FIG. 1 is a diagram of a method 100 for project management black box protections, according to an example embodiment. The method 100 (hereinafter “black box service”) is implemented as instructions in a machine-accessible and readable medium. The instructions when executed by a machine perform the processing depicted in FIG. 1. The black box service is also operational over and processes within a network. The network may be wired, wireless, or a combination of wired and wireless.

As will be more fully described herein and below, the black box service permits a project to have additional security enforced within any particular stage of its lifecycle processing. It is also noted that each processing environment for each stage or a project's lifecycle may include processing instances of the black box service. Each processing instance may interact with the other processing instances in the manners more completely described herein and below.

At 110, the black box service receives a request from a first principal to take an action on behalf of the first principal within a first processing environment. The request is received with a context of a first stage for a lifecycle of a project. In other words, a variety of resources associated with a project are in various stages of usage within the first processing environment, when the first principal makes a request (directly or indirectly) for some action to be taken on behalf of the first principal and in connection with the project and its first stage processing.

According to an embodiment, at 111, the black box service receives the request in response to an evaluation of a first stage policy that indicates the action is associated with a sensitive resource for which third-party intervention is called for. In response to this evaluation, the request is raised on behalf of the first principal for purposes of prompting the third-party processing. That is, the first principal may be attempting to access a confidential data store or sensitive device, where policy dictates that on a designated third-party service or resource is permitted to access that data store or device.

In an embodiment, the black box service may recognize the action being requested as a variety of different types of processing, such as: a request for access to confidential data, a request for access to a private service, a request for access to a secure device, a request for permission to transition from the first stage of the project to a second stage of the project, request permission to transition from the first stage to a preceding or previous stage of the lifecycle for the project, and/or a request for remote action to be taken from a down stage or upstage secure resource.

At 120, the black box service authenticates the first principal in response to the request being received for processing. The first principal may or may not have already been authenticated for processing within the first processing environment and for access to resources associated with the first stage of the project lifecycle, but the request for the action triggers additional authentication to take place for added protections associated with the action.

In some cases, at 121, the black box service uses a customized authentication policy to determine an authentication mechanism to use when authenticating the first principal.

In another situation, at 122, the black box service enlists a third-party identity service to perform authentication of the first principal. Example identity services that may be used to assist in this third-party authentication were described and incorporated by reference above.

At 130, the black box service evaluates policy when the first principal is successfully authenticated for processing the action. The policy drives conditions under which the action may be performed on behalf of the first principal and in some cases may also dictate specific resources that are permitted to perform the action on behalf of the first principal. This ensures a custom level of security for processing the action. So, the action may be constrained by policy to be processed by a particular resource, within a particular processing environment, within a particular stage of the project, etc.

Assuming, at 140, that the policy permits processing and that the first principal was successfully authenticated, the black box service takes the action on behalf of the first principal. Again, any of the above enumerated actions may be taken and taken in the manners described above. The types of actions and the manner in which the actions are processed are driven by the policy evaluation.

In an embodiment, at 150, the black box service dynamically authenticates a down stage or upstage secure resource located in second processing environment as part of taking the action on behalf of the first principal. Additionally, the black box service requests that the secure resource take one or more additional actions on behalf of the first principal and as part of the processing associated with taking the initial action. For example, the secure resource may be another instance of the black box service located in a second stage and second processing environment, and the action being processed may be a promotion request to transition the project from the first stage to the second stage. The second black box service may have to authorize, via policy, the promotion, and the first black box service may have to dynamically authenticate to the second black box service before the promotion can take place.

According to an embodiment, at 160, the black box service accesses a secure resource within the first processing environment to acquire an access key or token. That access key or token is then supplied to the first principal as part of taking the action on behalf of the first principal. Moreover, the access key or token can be used to promote the project to a next or down stage environment associated with the lifecycle of the project or used to access sensitive data or devices in connection with first stage processing.

The processing associated with the black box service demonstrates how automated project lifecycle management can deploy and implemented custom security within each particular stage. This security is above and beyond any normal security associated with the project or its lifecycle stages. The black box service uses policy to determine when an action being taken necessitates additional security and can deploy its own custom or third-party authentication to ensure procedures are followed and that proper credentials are acquired. Then, only the policy-dictated resource performs the action being requested. In some cases, this action may be a project promotion to a next or down stage processing environment for the project in other cases this action may be access to sensitive data, devices, or any other sensitive resources.

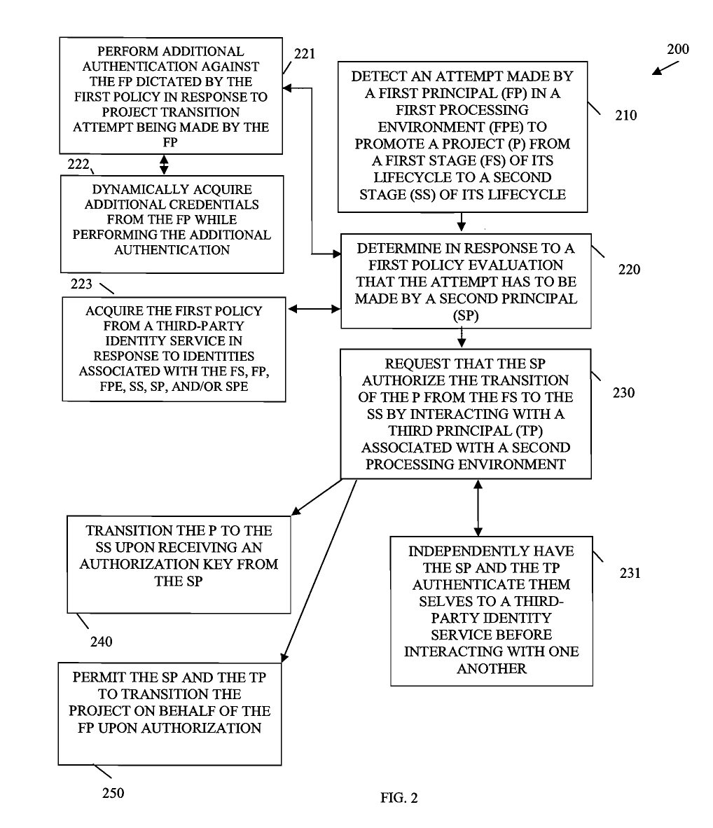

FIG. 2 is a diagram of a method 200 for facilitating project management black box protections, according to an example embodiment. The method 200 (hereinafter “security facilitation service”) is implemented as instructions in a machine-accessible and readable medium. The instructions when executed by a machine perform the processing depicted in FIG. 2. The security facilitation service is also operational over and processes within a network. The network may be wired, wireless, or a combination of wired and wireless.

The security facilitation service represents front-end processing associated with black box service represented by the method 100 discussed above with the FIG. 1. In other words, the security facilitation service can be used as an enhancement service within a first processing environment to invoke the black box service and manage actions or load associated with the black box service.

At 210, the security facilitation service detects that an attempt is being made by a first principal in a first processing environment to promote/transition a project from a first stage of its lifecycle to a second stage of its lifecycle. Although the term “promote” implies an upgrade and the term “second” implies a down stream or subsequent stage; this scenario does not have to always be the case herein in the context of the processing associated with the security facilitation service.

In other words, the promotion may be to move (transition) a project from a higher down stream stage back to a lower up stream stage. So, the project may be in effect demoted from, for example, production to development. Of course the other way can work as well, where the project is promoted, for example, from development to production.

It is also understood that the stages are user-defined, such that the labels associated with a lifecycle stage and an order of the lifecycle stages relative to one another can be custom configured and defined. The point is that an attempt is made by a first principal to transition a project from its existing stage (first stage within a first processing environment) to a different stage (second stage within a second processing environment).

At 220, the security facilitation service determines in response to a first policy evaluation that the attempt has to be made by a second principal. That is, the first policy dictates that the first principal requesting the transition (promotion) of the project from the first stage to the second stage has to be done by a second principal that is different from the first principal.

In some cases, at 221, the first principal may not even be capable of making the transition request without additional authentication for added security. Accordingly, the security facilitation service can perform additional authentication against the first principal. The additional authentication and/or authentication mechanisms used may be driven or dictated within the first policy. At 222, the security facilitation service can dynamically acquire additional credentials from the first principal while performing the additional authentication. In other words, some additional information may be dynamically requested of the first principal to ensure that the transition attempt is proper and securely being made.

In an embodiment, at 223, the security facilitation service acquires the first policy from a trusted third-party identity service. The particular first policy may be returned and acquired in response to identities associated with the first stage, the first processing environment, the first principal, the second stage, the second processing environment, and/or the second principal. So, the identity service can manage the policy distribution, since it knows and manages the identities for the resources interacting within the lifecycle management network.

At 230, the security facilitation service requests that the second principal authorize the transition of the project from the first stage to the second stage by requesting that the second principal interact with a third principal associated with the second processing environment of the second stage.

The second principal may be viewed as a black box service, such as the black box service represented by the method 100. The security facilitation service facilitates calling the second principal (black box service) to transition the project on behalf of a first principal (e.g., user, automated service, etc.) from the first stage to a second stage. In the second processing environment of the second stage another instance of a secure black box service referred to as a third principal is present and that third principal (black box service) interacts with the second principal (another black box service) to ensure the transition occurs in a secure and trusted manner that is driven by policy.

In an embodiment, at 231, the security facilitation service may independently have the second principal and the third principal authenticate themselves to a third party identity service before interacting with one another. So, two black box services dynamically authenticate for interacting with one another via an identity service. This further increases the security of the technique and ensure that just trusted communications are occurring when a project is being promoted or transitioned from a first stage to a second stage.

In another situation, at 240, the security facilitation service may actually transition the project to the second stage independent of the second or third principals. In this scenario, the second and third principal's interact to supply an authorization key or token to the security facilitation service. That key can then be presented and used by the security facilitation service or even the first principal to transition the project from the first processing environment and first stage to the second processing environment and the second stage. So, the first and second principals may interact to produce authorization keys that the security facilitation service or the first principal uses to transition the project when desired. In some embodiments, the key may include expiring events or conditions, which if occur require the security facilitation service and first principal to re-acquire a new authorization key or token.

In yet another situation, at 250, the security facilitation service permits the second and third principals to transition the project on behalf of the first principal once authorization is achieved.

This scenario was described above and the point is that the second and third principals may be viewed as secure black box services that operate within their own independent processing environments, each processing environment associated with a different stage of a project's lifecycle. When a transition of the project lifecycle stage occurs, the two black box services authenticate to one another, evaluate policy, and cooperate to transition the project from the first stage and first processing environment to the second stage and second processing environment on behalf of the first principal.

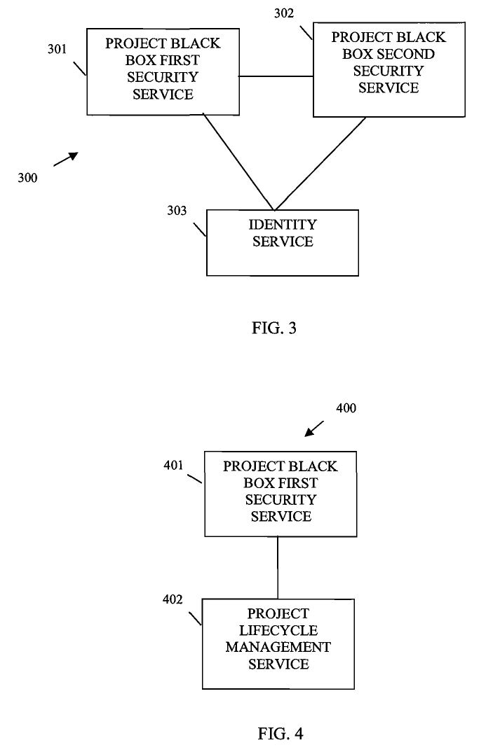

FIG. 3 is a diagram of a project management back box protection system 300, according to an example embodiment. The project management back box protection system 300 is implemented as instructions on or within a machine-accessible and readable medium. The instructions when executed by a machine perform various aspects of the processing depicted with respect to the method 100 of the FIG. 1. The project management back box protection system 300 is also operational over a network and the network may be wired, wireless, or a combination of wired and wireless.

The project management back box protection system 300 includes a project black box first security service 301 and a project black box second security service 302. In some cases, the project management back box protection system 300 may also include an identity service 303. Each of these components and their interactions with one another will now be discussed in turn.

The project black box first security service 301 is implemented in a machine-accessible and readable medium and is to process on a machine within a first processing environment of the network. Example processing associated with the project black box first security service 301 was described in detail above with reference to the black box service represented by the method 100 of the FIG. 1.

The project black box first security service 301 facilitates transitioning a project and its selective resources from a first stage of its lifecycle within the first processing environment to a second stage of its lifecycle within a second processing environment. This is achieved by the project black box first security service 301 dynamically interacting with the project black box second security service 302.

Specifically, the project black box first security service 301 monitors or listens for selective actions or events within the first processing environment. These selective actions or events are defined by policy and when detected as being associated with a first principal, the project black box first security service 301 is invoked.

For example, the project black box first security service 301 may detect via a policy that a first principal is attempting to transition the project and its selective resources from the first stage of the first processing environment to the second stage of the second processing environment. In response to this detection, the project black box first security service 301 uses other policy to drive actions to take, such acquire additional credentials from the first principal, acquire proper authorization keys from the project black box second security service 302, etc.

According to an embodiment, the project black box first security service 301 also manages and distributes sensitive data within the first processing environment. So, access keys/tokens or confidential data may be distributed and managed by the project black box first security service 301, such that the first principal can authenticate to the project black box first security service 301 and acquire desired access keys/tokens or confidential data. In some case, the access tokens may provide an authorization to transition the project to the second processing environment and the second stage via the project black box second security service 302.

The project black box second security service 302 is implemented in a machine-accessible and readable medium and is to process on a different machine within a second processing environment of the network. Example processing associated with the project black box second security service 302 may also be represented by the black box service depicted above with reference to the method 100 of the FIG. 1.

The project black box second security service 302 operates within the second processing environment and is associated with resources of the second stage for the project. Policy drives whether any particular project can transition to the second stage associated with the second processing environment without first consulting the project black box second security service 302. When policy dictates authorization from the project black box second security service 302, the project black box first security service 301 dynamically authenticates to and acquires authorization from the project black box second security service 302 to transition the project from the first stage and the first processing environment to the second stage and the second processing environment. The project black box second security service 302 performs the same security features within the second stage of the project that the project black box first security service 301 performs for the first stage of the project.

In some cases, the project management back box protection system 300 also includes an identity service 303. The identity service 303 is implemented in a machine-accessible and readable medium and is to process on a different machine of the network within a third and different processing environment. Example identity services were discussed and incorporated by reference herein and above.

The identity service 303 is used to independent authenticate resources of the lifecycle management network. Thus, the identity service 303 independently authenticates the project black box first security service 301 and the project black box second security service 302 for interacting with one another for purposes of securely transitioning the project from the first stage to the second stage and across disparate processing environments (from the first processing environment to the second processing environment).

According to an embodiment, the identity service 303 is also used to distribute and manage the policy, which is evaluated by the project black box first security service 301 in view of an identity assigned to the first principal. The identity assigned to the first principal is also acquire from or assigned by the identity service 303.

FIG. 4 is a diagram of another project management black box protection system 400, according to an example embodiment. The project management black box protection system 400 is implemented as instructions on or within a machine-accessible and readable medium. The instructions when executed by a machine perform various aspects of the processing depicted with respect to the methods 100 and 200 of the FIGS. 1 and 2, respectively, and processing associated with the system 300 of the FIG. 3. The project management black box protection system 400 is also operational over a network and the network may be wired, wireless, or a combination of wired and wireless.

The project management black box protection system 400 includes a project black box first security service 401 and a project lifecycle management service 402. Each of these components and their interactions with one another will now be discussed in turn.

The project black box first security service 401 is implemented in a machine-accessible and readable medium and is to process on a machine within a first processing environment of the network. Example processing associated with the project black box first security service 401 was described above in detail with reference to the method 100 of the FIG. 1 and with reference to the system 300 of the FIG. 3.

The project black box first security service 401 is selectively invoked for processing by the project lifecycle management service 402. Once invoked, the project black box first security service 401 performs a lifecycle management operation on behalf of a requesting or first principal (e.g., user or automated service, etc.).

The lifecycle management operation can include, by way of example only, any of the following operations: acquiring an access key for access to a secure resource, acquiring confidential data from the secure resource, requesting that the secure resource perform a variety of actions on behalf of a requesting principal, and/or promoting a project associated with a requesting or first principal from a first stage to a second stage in a second processing environment.

In an embodiment, the project black box first security service 401, while or during processing the lifecycle management operation on behalf of the first principal, interacts with a project black box second security service (not shown in FIG. 4) in an entirely different processing environment from that which is associated with the project black box first security service 401.

So, each stage of a project's lifecycle may have its own processing environment and its own resources and each unique processing environment can include an instance of the project black box first security service 401. The different instances are designed to cooperate and communicate with one another from their respective processing environments for purposes of securely processing lifecycle management operations on behalf of requesting or first principals.

The project lifecycle management service 402 is implemented in a machine-accessible and readable medium and is to process on a machine within the first processing environment of the network. Example processing associated with the project lifecycle management service 402 was described above in detail with reference to the method 200 of the FIG. 2.

The project lifecycle management service 402 monitors activities of the first principal within the first processing environment in view of first policy. When the policy dictates, the project lifecycle management service 402 invokes the project black box first security service 401 to have that project black box first security service 401 perform a lifecycle management operation on behalf of the first principal.

In an embodiment, the project lifecycle management service 402 interacts with an identity service (not shown in FIG. 4) to acquire the first policy and to acquire or identity authentication services for the first principal and the project black box first security service 401. As part of these authentication services, the policy may dictate that the project lifecycle management service 402 acquire additional credentials from the first principal beyond what was initially and previously supplied by the first principal. This may be done for a lifecycle management operation in which the project is being promoted from a first stage to a second stage of its lifecycle and added or enhanced security is desired.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
receiving a request from a first principal to take an action on behalf of the first principal within a first processing environment, wherein the request is received within a context of a first stage for a lifecycle of a project;
authenticating the first principal;
evaluating policy when the first principal is successfully authenticated; and
taking the action on behalf of the first principal when policy permits.

2. The method of claim 1, wherein receiving further includes receiving the request in response to evaluation of a first stage policy that indicates the action being attempted by the first principal is associated with access to a sensitive resource for which third-party processing intervention is called for and raising the request to prompt that third-party processing.

3. The method of claim 1, wherein receiving the request further includes recognizing the action as one or more of the following:
requesting access to confidential data;
requesting access to a private service;
requesting access to a secure device;
requesting permission to transition from the first stage of the project to a second stage of the project;
requesting permission to transition from the first stage back to a previous stage of the lifecycle for the project, wherein the previous stage preceded the first stage in the lifecycle; and
requesting remote action from a down stage or upstage secure resource.

4. The method of claim 1, wherein authenticating further includes using an authentication policy to determine an authentication mechanism to use for authenticating the first principal.

5. The method of claim 1, wherein authenticating further includes enlisting a third-party identity service to perform the authentication of the first principal.

6. The method of claim 1, wherein taking further includes:
dynamically authenticating to a down stage or upstage secure resource located in a second processing environment as part of taking the action on behalf of the first principal; and
requesting that the secure resource take one or more additional actions.

7. The method of claim 1, wherein taking further includes accessing a secure resource within the first processing environment to acquire an access key and supplying the access key to the first principal.

8. A method, comprising:
detecting an attempt made by a first principal in a first processing environment to promote a project from a first stage of its lifecycle to a second stage of its lifecycle;
determining in response to a first policy evaluation that the attempt has to be made by a second principal;
requesting that the second principal authorize the transition of the project from the first stage to the second stage by interacting with a third principal associated with the a second processing environment of the second stage.

9. The method of claim 8 further comprising, transitioning the project to the second stage upon receiving an authorization key from the second principal.

10. The method of claim 8 further comprising, permitting the second principal and the third principal to transition the project on behalf of the first principal upon authorization.

11. The method of claim 8, wherein determining further includes performing additional authentication against the first principal, wherein the first principal is already authenticated within the first processing environment and the additional authentication is dictated by the first policy in response to the project transition attempt being made by the first principal.

12. The method of claim 11 further comprising, dynamically acquiring additional credentials from the first principal while performing the additional authentication.

13. The method of claim 8, wherein determining further includes acquiring the first policy from a third-party identity service in response to identities associated with one or more of the following: the first stage, the first principal, the first processing environment, the second stage, the second principal, and the second processing environment.

14. The method of claim 8, wherein requesting further includes independently having the second principal and the third principal authenticate them selves to the third-party identity service before interacting with one another.

15. A system, comprising:
a project black box first security service implemented in a machine-accessible and readable medium and to process on a machine within a first processing environment of a network; and
a project black box second security service implemented in a machine-accessible and readable medium and to process on a different machine within a second processing environment of the network;
wherein the project black box first security service facilitates transitioning a project from a first stage of its lifecycle within the first processing environment to a second stage of its lifecycle within the second processing environment by interacting with the project black box second security service, actions of the project black box first security service are triggered in response to policy evaluation vis-à-vis a first principal operating within the first processing environment when an attempt is made by the first principal to transition the project from the first stage to the second stage.

16. The system of claim 15, wherein the project black box first security service also manages and distributes sensitive data within the first processing environment by enforcing access policies.

17. The system of claim 15 further comprising, an identity service implemented in a machine-accessible and readable medium and to process on its own independent machine within a third processing environment of the network, wherein the identity service independently authenticates the project black box first security service and the project black box second security service for interacting with one another.

18. The system of claim 17, wherein the identity service manages and distributes the policy evaluated by the project black box first security service in response to an identity assigned to the first principal.

19. The system of claim 15, wherein the project black box first security service utilizes a first authentication mechanism to authenticate and interact with first resources of the first processing environment and the project black box second security service utilizes a second authentication mechanism to authenticate and interact with second resources of the second processing environment, and wherein the first and second authentication mechanisms are independent of one another and different from one another.

20. The system of claim 15, wherein the project black box first security service dynamically requests additional credentials from the first principal when the first principal attempts to transition the project from the first stage to the second stage.

21. A system, comprising:
a project black box first security service implemented in a machine-accessible and readable medium and to process within a first processing environment of a network; and
a project lifecycle management service implemented in a machine-accessible and readable medium and to process with the first processing environment of the network;
wherein the project lifecycle management service is to monitor activities of a first principal within the first processing environment with respect to a first policy and when dictated by the first policy invoke the project black box first security service to perform a lifecycle management operation on behalf of the first principal.

22. The system of claim 21, wherein the lifecycle management operation includes one or more of the following: acquiring an access key for access to a secure resource, acquiring confidential data from the secure resource, requesting that the secure resource perform one or more actions, and promoting a project associated with the first principal from a first stage to a second stage located in a second processing environment.

23. The system of claim 21, wherein the project lifecycle management service interacts with an identity service to acquire the first policy and to acquire authentication services for the first principal and the project black box first security service.

24. The system of claim 21, wherein the project lifecycle management service requests that the first principal supply additional credentials beyond what was previously supplied when the first policy dictates and when the lifecycle management operation is associated with promoting a project from a first stage of its lifecycle to a second stage of its lifecycle.

25. The system of claim 21, wherein the project black box first security service interacts with a project black box second security service associated with a second and different processing environment to perform the lifecycle management operation on behalf of the first principal.
